(19) United States
(12) Patent Application Publication
(10) Pub. No.: US 2015/0075955 A1
(43) Pub. Date: Mar. 19, 2015

(54) Reversing Switch

(71) Applicant: Yingjie Cai, Shanghai (CN)

(72) Inventor: Yingjie Cai, Shanghai (CN)

(73) Assignee: Shanghai Baicheng Electric Equipment Manufacture Co., Ltd., Shanghai (CN)

(21) Appl. No.: 13/996,787

(22) PCT Filed: Jun. 21, 2012
(86) PCT No.: PCT/CN2012/077384

§ 371 Date: Jul. 15, 2013

(30) Foreign Application Priority Data
May 28, 2012 (CN) 2012101704506

(51) Int. Cl. H01H 1/50; H01H 1/58; H01H 9/06

(52) U.S. Cl. CPC H01H 1/50; H01H 9/063; H01H 1/58
USPC 200/1 V

(57) ABSTRACT

The present disclosure provides a reversing switch, including a switch body, and input terminals and output terminals independent from each other and provided in pairs on the switch body; each pair comprising one input terminal and one output terminal; wherein one of the input terminals is connected or disconnected with one of the output terminals via a plurality of independent reversing connectors, and the plurality of independent reversing connectors are configured to be movable synchronously. A plurality of independent reversing connectors are adopted between the input terminals and the output terminals of the reversing switch provided by the present disclosure to realize the connection and the disconnection between the input terminal and the output terminal, thus increasing the contact area between the reversing connectors and the input terminals or the output terminals, reducing the contact resistance, and improving the current loading capability of the reversing switch. In the meanwhile, the contact reliability could be ensured when the reversing switch is powered on because the number of contacts is increased, thereby effectively resisting the affection on the switch performance by shock and vibration.

### TECHNICAL FIELD OF THE INVENTION

The present disclosure relates to the field of switch technology of electrical system, and more particularly to a reversing switch.

### BACKGROUND OF THE INVENTION

Currently, there are basically two major types of positive and negative rotation mechanisms adopted by the reversing switch on the market:

The first type is an electronic positive and negative rotation mechanism, which realizes the function of positive and negative rotation of a motor through connection of electronic circuits.

The second type is a mechanical positive and negative rotation mechanism, which realizes the function of positive and negative rotation of a motor through connection of mechanical structures.

The former type is rarely applied because of high cost, while the latter type is widely applied because of lower cost and easy implementation.

Wherein, the mechanical positive and negative rotation mechanism further includes a side contact type: relative to the working parts of a positive and negative rotation connection component, the corresponding working parts of an input end 1, an input end 2, an output end 1 and an output end 2 are all located at a side thereof. This type of positive and negative rotation mechanism has the following problems: each loop (e.g. the input end 1 (2), the positive and negative rotation connection component, and the output end 1 (2) constitute a loop) is connected via a separate positive and negative rotation connection component, which means there is only a single connection contact point in each loop. It is well known that there is a contact resistance in the connection part of each loop, and the contact resistance depends on the size of the contact area under the condition of identical materials and equal contact pressure etc. The larger the contact resistance is, the larger the internal resistance of the loop (the internal resistance of the loop=the material internal resistance+the contact resistance) will be. In case of electricity, the larger the internal resistance is, the higher the heat is. Further, in the energized state, the switch will bear certain impact and vibration inevitably, and the single connection contact point will cause loose contact of the contact part easily so that the working performance of the switch will be affected because of the severe heat.

### SUMMARY OF THE INVENTION

The purpose of the present disclosure is to provide a reversing switch to solve the technical problem that a reversing loop of a side contact reversing switch in the art has larger internal resistance and is easy to produce heat while the performance of shock resistance and vibration resistance is poor.

To realize the purpose above, the present disclosure provides a reversing switch, comprising a switch body, and input terminals and output terminals independent from each other and provided in pairs on the switch body; each pair comprising one input terminal and one output terminal; wherein one of the input terminals is connected or disconnected with one of the output terminals via a plurality of independent reversing connectors, and the plurality of independent reversing connectors are configured to be movable synchronously.

Further, the input terminals comprise a first input terminal and a second input terminal; the output terminals comprise a first output terminal and a second output terminal; the first input terminal, the first output terminal, the second input terminal and the second output terminal are provided along the circumferential direction of the switch body in turn; the reversing connectors comprise a first group of reversing connectors and a second group of reversing connectors; the first input terminal is selectively connected to the first output terminal through the first group of reversing connectors or to the second output terminal through the second group of reversing connectors; the second input terminal is selectively connected to the first output terminal through the first group of reversing connectors or to the second output terminal through the second group of reversing connectors.

Further, the first group of reversing connectors comprises a first reversing connector and a second reversing connector provided along the thickness direction of the switch body and in parallel; the second group of reversing connectors comprises a third reversing connector and a fourth reversing connector provided along the thickness direction of the switch body and in parallel.

Further, a rotor installation groove is provided in the switch body; a reversing rotor is provided in the rotor installation groove, and the reversing connectors are provided on a side wall of the reversing rotor.

Further, the side wall of the reversing rotor is provided with connector installation slots which are independent from each other and of which the number and location are correspond to that of the reversing connectors, and each of the reversing connectors is provided in one of the connector installation slots correspondingly.

Further, a first side of the reversing rotor is provided with a first connector installation slot and a second connector installation slot independently provided along the axial direction of the reversing rotor and in parallel; the first reversing connector and the second reversing connector are provided in the first connector installation slot and the second connector installation slot, respectively; a second side of the reversing rotor is provided with a third connector installation slot and a fourth connector installation slot independently provided along the axial direction of the reversing rotor and in parallel; the third reversing connector and the fourth reversing connector are provided in the third connector installation slot and the fourth connector installation slot, respectively.

Further, the input terminals and the output terminals are located outside the switch body, and the input terminals and the output terminals are connected to the reversing connectors through input terminal connectors and output terminal connectors inside the switch body respectively; the input terminal connectors and the output terminal connectors are located between an outer surface of the reversing rotor and an inner side wall of the rotor installation groove.

Further, the reversing connectors are U-shaped reversing connectors; the connector installation slots are U-shaped grooves, and an arc bottom of the U-shaped reversing connector is connected to the input terminal connector and/or the output terminal connector.

Further, a top of the reversing rotor is provided with a reversing handle for controlling the rotation of the reversing rotor.

The present disclosure has the following beneficial effect:

The reversing switch provided by the present disclosure includes a switch body, and input terminals and output terminals independent from each other and provided in pairs on the switch body. Each pair includes one input terminal and one output terminal, wherein one of the input terminals is connected or disconnected to one of the output terminals via a plurality of independent reversing connectors, which are configured to be movable synchronously. The plurality of independent reversing connectors are adopted between the input terminals and the output terminals of the reversing switch provided by the present disclosure to realize the connection and the disconnection between the input terminal and the output terminal, thus increasing the contact area between the reversing connectors and the input terminals or the output terminals, reducing the contact resistance, and improving the current loading capability of the reversing switch. In the meanwhile, the contact reliability could be ensured when the reversing switch is powered on because the number of contacts is increased, thereby effectively resisting the affection on the switch performance by shock and vibration.

Besides the purpose, characteristics and advantages described above, the present disclosure further has other purposes, characteristics and advantages. The present disclosure will be further explained below in details with reference to the drawings.

### BRIEF DESCRIPTION OF THE DRAWINGS

The accompanying drawings which constitute a part of the present application are used for providing further understanding to the present disclosure. The exemplary embodiments of the present disclosure and the illustrations thereof are used for explaining the present disclosure, instead of constituting an improper limitation to the present disclosure. In the accompanying drawings:

FIG. 1 is a schematic view illustrating an internal structure of a reversing switch in a disconnected state in a preferred embodiment of the present disclosure;

FIG. 2 is a schematic view illustrating an internal structure of a reversing switch connected in a first direction in a preferred embodiment of the present disclosure;

FIG. 3 is a schematic view illustrating an integral structure of a reversing switch in a preferred embodiment of the present disclosure;

FIG. 4 is a schematic view illustrating an assembly structure of a reversing rotor and a reversing connector in a preferred embodiment of the present disclosure; and

FIG. 5 is a structural view illustrating two groups of reversing connectors in a preferred embodiment of the present disclosure.

### DETAILED DESCRIPTION OF THE EMBODIMENTS

The embodiments of the present disclosure will be described in details below in combination with the accompanying drawings, but the present disclosure may be implemented by various different methods limited and covered by the claims.

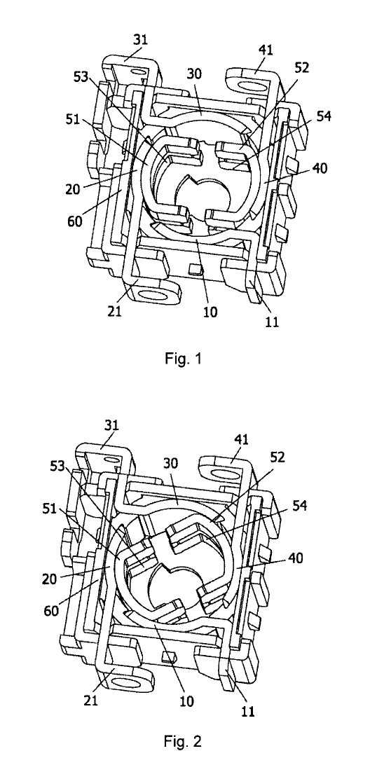

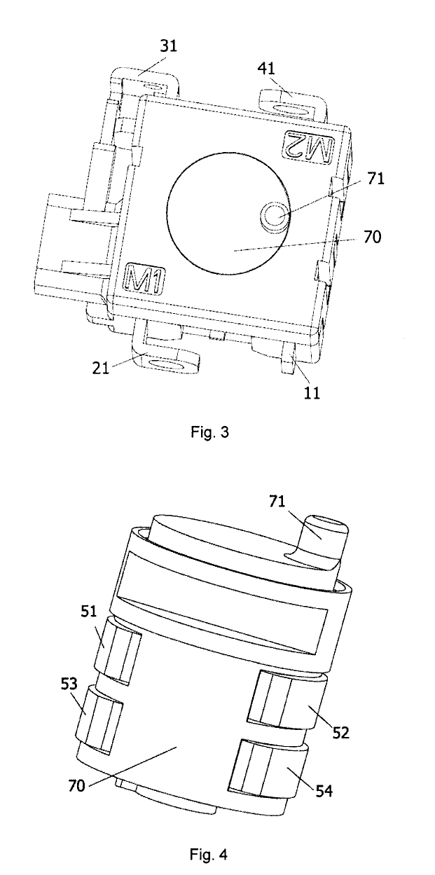

As shown in FIG. 1, FIG. 2 and FIG. 3, the present disclosure provides a reversing switch, which includes a switch body 60, and input terminals and output terminals independent from each other and provided in pairs on the switch body 60. Each pair includes one input terminal and one output terminal. One of the input terminals is connected or disconnected to one of the output terminals via a plurality of independent reversing connectors, and the plurality of independent reversing connectors are configured to be movable synchronously. The plurality of independent reversing connectors are adopted between the input terminals and the output terminals of the reversing switch provided by the present disclosure to realize the connection and the disconnection between the input terminal and the output terminal, thus increasing the contact area between the reversing connectors and the input terminals or the output terminals, reducing the contact resistance, and improving the current loading capability of the reversing switch. In the meanwhile, the contact reliability could be ensured when the reversing switch is powered on because the number of contacts is increased, thereby effectively resisting the affection on the switch performance by shock and vibration.

The input terminals include a first input terminal 11 and a second input terminal 31; the output terminals include a first output terminal 21 and a second output terminal 41. The first input terminal 11, the first output terminal 21, the second input terminal 31 and the second output terminal 41 are provided along the circumferential direction of the switch body 60 in turn. The reversing connectors include a first group of reversing connectors and a second group of reversing connectors. The first input terminal 11 is selectively connected to the first output terminal 21 through the first group of reversing connectors or to the second output terminal 41 through the second group of reversing connectors. The second input terminal 31 is selectively connected to the first output terminal 21 through the first group of reversing connectors or to the second output terminal 41 through the second group of reversing connectors.

As a specific embodiment, the first group of reversing connectors may include a first reversing connector 51 and a second reversing connector 53 provided along the thickness direction of the switch body 60 and in parallel; the second group of reversing connectors may include a third reversing connector 52 and a fourth reversing connector 54 provided along the thickness direction of the switch body 60 and in parallel. The reversing connectors are not connected to one another. Actually, the number of the reversing connectors in each group of reversing connectors is not limited to 2, and the number of the reversing connectors may be increased according to actual conditions. However, limited by the volume of the switch body 60, the width, extending along the direction of the thickness of the switch body 60, of each reversing connector will be reduced correspondingly with the increase of the number of the reversing connectors in each group. Although the width of each reversing connector is reduced, the contact area and the number of contact points between two ends of each group of reversing connectors and the input terminal connectors or the output terminal connectors are increased, so the stability of the reversing switch on the whole could still be increased. Of course, the width of each reversing connector does not have to be reduced if the volume of the switch body 60 allows, which depends on the limitation of the specific size.

Specifically, the input terminals and the output terminals are located outside the switch body 60, and the input terminals and the output terminals are connected to the reversing connectors through input terminal connectors and output terminal connectors inside the switch body 60 respectively.

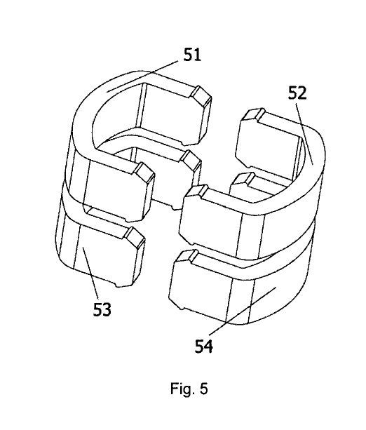

As shown in FIG. 4 and FIG. 5, in order to realize the reversing function, a rotor installation groove is provided in the switch body 60; a reversing rotor 70 is provided inside the rotor installation groove, and the reversing connectors are provided on a side wall of the reversing rotor 70; the input terminal connectors and the output terminal connectors are located between an outer surface of the reversing rotor 70 and an inner side wall of the rotor installation groove. The side wall of the reversing rotor 70 is provided with connector installation slots which are independent with one another and of which the number and location are correspond to that of the reversing connectors, and each of the reversing connectors is provided in one of the connector installation slots correspondingly.

Correspondingly, a first side of the reversing rotor 70 is provided with a first connector installation slot and a second connector installation slot independently arranged along the axial direction of the reversing rotor 70 and in parallel; the first reversing connector 51 and the second reversing connector 53 are provided in the first connector installation slot and the second connector installation slot, respectively; a second side of the reversing rotor 70 is provided with a third connector installation slot and a fourth connector installation slot independently arranged along the axial direction of the reversing rotor 70 and in parallel; the third reversing connector 52 and the fourth reversing connector 54 are provided in the third connector installation slot and the fourth connector installation slot, respectively.

The reversing connectors are U-shaped reversing connectors; the connector installation slots are U-shaped grooves, and a bottom of the U-shaped reversing connector is connected to the input terminal connector and/or the output terminal connector.

A top of the reversing rotor 70 is provided with a reversing handle 71 for controlling the rotation of the reversing rotor 70.

When the reversing switch of the disclosure is in a disconnected state, each group of reversing connectors cannot be connected to any one of the input terminals and any one of the output terminals at the same time, which means that a connected loop cannot be formed. For example, as shown in FIG. 1, the first group of reversing connectors is only connected to the first output terminal connector 20 and the second group of reversing connectors is only connected to the second output terminal connector 40. When the reversing switch needs to be in a working state, as shown in FIG. 2, the reversing switch may be connected in a first direction through rotating the reversing rotor 70: the first input terminal 11 and the first output terminal 21 are connected through the first reversing connector 51 and the second reversing connector 53; the second input terminal 31 and the second output terminal 41 are connected through the third reversing connector 52 and the fourth reversing connector 54. When it needs to implement the reversing connection, the reversing rotor 70 may be further rotated so that the reversing switch is connected in a second direction: the first input terminal 11 and the second output terminal 41 are connected through the third reversing connector 52 and the fourth reversing connector 54, and the second input terminal 31 and the first output terminal 21 are connected through the first reversing connector 51 and the second reversing connector 53.

Actually, the reversing switch provided by the present disclosure can solve the technical problems of small contact area, large internal resistance, poor shock resistance, and poor vibration resistance between the reversing connectors and the input terminals or the output terminals. It is not only applicable to the case that the reversing connectors are provided at the side of the switch body 60, but also applicable to the case that the reversing connectors are provided at one end of the switch body 60.

The above are only preferred embodiments of the present disclosure and should not be used to limit the present disclosure. For those skilled in the art, the present disclosure may have various modifications and changes. Any modifications, equivalent replacements, improvements and the like within the spirit and principle of the present disclosure shall fall within the scope of protection of the present disclosure.

What is claimed is:

1. A reversing switch, comprising a switch body (60), and input terminals and output terminals independent from each other and provided in pairs on the switch body (60); each pair comprising one input terminal and one output terminal; wherein one of the input terminals is connected or disconnected with one of the output terminals via a plurality of independent reversing connectors, and the plurality of independent reversing connectors are configured to be movable synchronously.

2. The reversing switch according to claim 1, wherein
the input terminals comprise a first input terminal (11) and a second input terminal (31);
the output terminals comprise a first output terminal (21) and a second output terminal (41); the first input terminal (11), the first output terminal (21), the second input terminal (31) and the second output terminal (41) are provided along the circumferential direction of the switch body (60) in turn;
the reversing connectors comprise a first group of reversing connectors and a second group of reversing connectors; the first input terminal (11) is selectively connected to the first output terminal (21) through the first group of reversing connectors or to the second output terminal (41) through the second group of reversing connectors; the second input terminal (31) is selectively connected to the first output terminal (21) through the first group of reversing connectors or to the second output terminal (41) through the second group of reversing connectors.

3. The reversing switch according to claim 2, wherein the first group of reversing connectors comprises a first reversing connector (51) and a second reversing connector (53) provided along the thickness direction of the switch body (60) and in parallel; the second group of reversing connectors comprises a third reversing connector (52) and a fourth reversing connector (54) provided along the thickness direction of the switch body (60) and in parallel.

4. The reversing switch according to claim 3, wherein a rotor installation groove is provided in the switch body (60); a reversing rotor (70) is provided in the rotor installation groove, and the reversing connectors are provided on a side wall of the reversing rotor (70).

5. The reversing switch according to claim 4, wherein the side wall of the reversing rotor (70) is provided with connector installation slots which are independent from each other and of which the number and location are correspond to that of the reversing connectors, and each of the reversing connectors is provided in one of the connector installation slots correspondingly.

6. The reversing switch according to claim 4, wherein
a first side of the reversing rotor (70) is provided with a first connector installation slot and a second connector installation slot independently provided along the axial direction of the reversing rotor (70) and in parallel; the first reversing connector (51) and the second reversing connector (53) are provided in the first connector installation slot and the second connector installation slot, respectively;
a second side of the reversing rotor (70) is provided with a third connector installation slot and a fourth connector installation slot independently provided along the axial direction of the reversing rotor (70) and in parallel; the third reversing connector (52) and the fourth reversing connector (54) are provided in the third connector installation slot and the fourth connector installation slot, respectively.

7. The reversing switch according to claim 5, wherein the input terminals and the output terminals are located outside the switch body (60), and the input terminals and the output terminals are connected to the reversing connectors through input terminal connectors and output terminal connectors inside the switch body (60) respectively; the input terminal connectors and the output terminal connectors are located between an outer surface of the reversing rotor (70) and an inner side wall of the rotor installation groove.

8. The reversing switch according to claim 5, wherein the reversing connectors are U-shaped reversing connectors; the connector installation slots are U-shaped grooves, and an arc bottom of the U-shaped reversing connector is connected to the input terminal connector and/or the output terminal connector.

9. The reversing switch according to claim 4, wherein a top of the reversing rotor (70) is provided with a reversing handle (71) for controlling the rotation of the reversing rotor (70).
